(19) United States
(12) Patent Application Publication
(10) Pub. No.: US 2011/0161060 A1
(43) Pub. Date: Jun. 30, 2011

(54) Optimization-Based exact formulation and solution of crowd simulation in virtual worlds

(76) Inventors: Changkyu Kim, San Jose, CA (US); Stephen J. Guy, Carrboro, NC (US); Anthony-Trung D. Nguyen, Castro Valley, CA (US); Daehyun Kim, San Jose, CA (US); Jatin Chhugani, Santa Clara, CA (US)

(21) Appl. No.: 12/655,362

(22) Filed: Dec. 29, 2009

(51) Int. Cl. G06F 17/11; G06G 7/60

(52) U.S. Cl. 703/2; 703/6

(57) ABSTRACT

A method of computing a collision-free velocity (117, 217) for an agent (110) in a crowd simulation environment (100) comprises identifying a quadratic optimization problem that corresponds to the collision-free velocity, and finding an exact solution for the quadratic optimization problem by using a geometric approach.

### FIELD OF THE INVENTION

The disclosed embodiments of the invention relate generally to computer-generated imagery, and relate more particularly to crowd simulation tasks in computer-generated imagery.

### BACKGROUND OF THE INVENTION

Virtual World applications (e.g., Second Life) are becoming an important component of the Connected Visual Computing (CVC) paradigm. One of the important tasks to be executed is the A.I. (artificial intelligence), wherein the characters in the virtual world perform specific assigned tasks and navigate through the world. The character navigation, also referred to as Crowd Simulation, is a computationally intensive task, and existing algorithms can only simulate a few thousands of agents in real-time. This is an order of magnitude from supporting the tens to hundreds of thousands of agents that would be required to generate a realistic virtual world scenario.

### BRIEF DESCRIPTION OF THE DRAWINGS

The disclosed embodiments will be better understood from a reading of the following detailed description, taken in conjunction with the accompanying figures in the drawings in which:

FIG. 1 is a representation of a simple crowd simulation scenario involving three agents according to an embodiment of the invention;

FIG. 2 is an illustration of a geometric approach to the discovery of a collision-free in a crowd simulation scenario according to an embodiment of the invention;

FIG. 3 is a flowchart illustrating a method of computing a collision-free velocity for an agent in a crowd simulation environment according to an embodiment of the invention; and

FIG. 4 is a flowchart illustrating a method of computing a collision-free velocity for an agent in a crowd simulation environment in which the agent has an initial velocity and is associated with a plurality of obstacle cones residing in a velocity space according to an embodiment of the invention.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements, while similar reference numerals may, but do not necessarily, denote similar elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

### DETAILED DESCRIPTION OF THE DRAWINGS

In one embodiment of the invention, a method of computing a collision-free velocity for an agent in a crowd simulation environment comprises identifying a quadratic optimization problem that corresponds to, the collision-free velocity, and finding an exact solution for the quadratic optimization problem by using a geometric approach.

Crowd Simulation in Virtual Worlds is of growing importance given the advent of 3D social networking sites. Likewise, Crowd Simulation is a growing component of the A.I. portion of the visual simulation loop. Computing collision-free velocities of the agents is the most time consuming part of the Crowd Simulation algorithm. The method most commonly used today is called RVO (Reciprocal Velocity Obstacle), wherein obstacle cones are formed for an agent in the velocity space, and a velocity that maximizes the time to collision with these cones is computed. The algorithm uses a sampling based method, where a set of 200-300 samples is chosen from a uniform distribution of points, and the sample that maximizes the time to collision is chosen as the velocity for the next time step of the agent. This method is not even guaranteed to find a collision-free velocity, and in fact often leads to collisions among agents.

In contrast, embodiments of the invention formulate the collision-free velocity problem as a quadratic optimization problem and solve it exactly using a geometric approach, as will be further described below. (A quadratic optimization problem seeks an optimal value where the optimization function is quadratic and the constraint functions are linear.) Embodiments of the invention enable local collision-avoidance velocities of the agents to be computed significantly faster than currently-used methods and enable the generation of realistic 3D crowd simulations, new use-case scenarios, and richer user experience. The disclosed methods are applicable to modern 3D games as well, since these are a specific instance of Virtual Worlds.

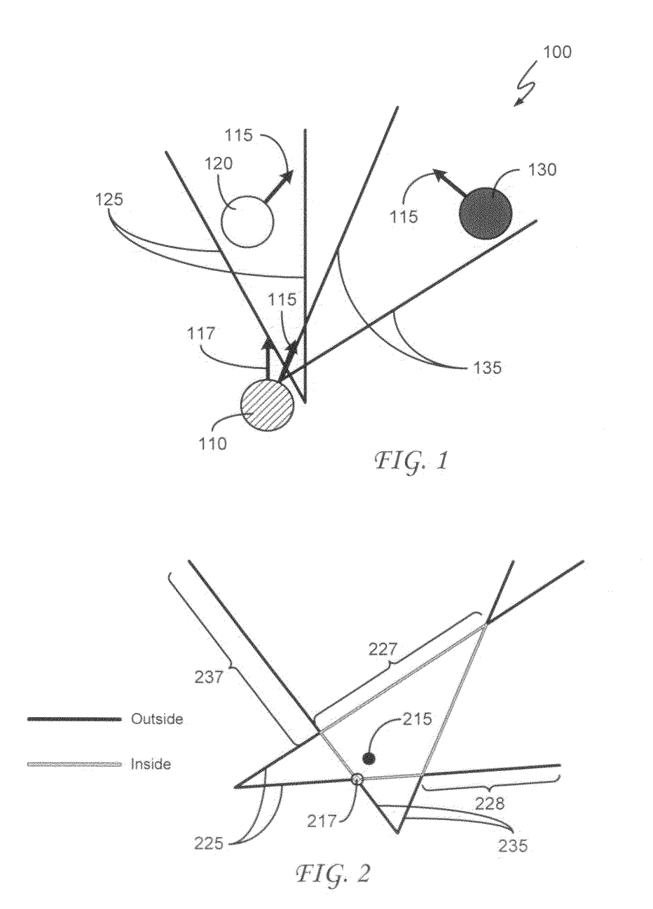

Referring now to the drawings, FIG. 1 is a representation in velocity space of a simple crowd simulation scenario 100 involving three agents according to an embodiment of the invention. As illustrated in FIG. 1, the three agents include an agent 110 along with agents 120 and 130 that agent 110 must avoid. Arrows 115 (one for each of agents 110, 120, and 130) represent the preferred velocity (e.g., found using calculations according to embodiments of the invention) for each agent in the next frame. Obstacle cones 125 and 135 represent the velocity obstacles for agent 110 corresponding, respectively, to agents 120 and 130. These velocity obstacles constitute the velocity regions that will lead to collisions with the other agents. In other words, each point inside the cones corresponds to a velocity that will eventually result in a collision between agent 110 and one or both of agents 120 and 130 (as long as those agents maintain a constant velocity), while every point outside both cones corresponds to a collision-free velocity. Of course, agents 120 and 130 may very well exhibit changes in velocity from one moment to the next, making the assumption of constant velocity a poor one, but because the obstacle cones are updated each time step or update frame this potential problem is mitigated.

As shown, the velocity arrow 115 for agent 110 intersects obstacle cone 125, meaning a collision with agent 120 is imminent. A new velocity for agent 110 must therefore be computed in order to avoid the collision; this new velocity should lie outside of both obstacle cones. Referring still to FIG. 1, one such new velocity is represented by an arrow 117. Because this new velocity lies outside of obstacle cones 125 and 135 it will (based on the information known at the time depicted in the figure) allow agent 110 to avoid colliding with agents 120 and 130. Of course, arrow 117 represents only one of many possible collision-free velocities. This particular velocity was chosen because it lies outside of all of the obstacle cones and is closest to the original velocity, thus minimizing abrupt changes in velocity for agent 110 and enabling smooth and natural motion. The way in which this closest velocity is chosen will now be described in more detail.

As mentioned, embodiments of the invention compute the new (collision-free) velocity (which, it should be recalled, is a point in 2D velocity space) that lies outside all of the obstacle cones and deviates the least from the original velocity point. This may be done by minimizing the Euclidian distance of the new velocity from the original velocity to obtain the following quadratic optimization problem (in which (x₀, y₀) represents the original velocity and (x, y) represents the new velocity of the agent in question):

Minimize (x−x₀)²+(y−y₀)², such that Aᵢx+Bᵢy<Cᵢ for all cone segments. (1)

For N cones, there will be 2N such (linear) constraints.

Instead of using methods like interior point, active set, or conjugate gradient, embodiments of the invention exploit the geometric nature of the crowd simulation problem in order to compute the resultant velocity (x, y) geometrically. As an example, the appropriate resultant velocity can be visualized by manipulating obstacle cones in velocity space, as illustrated in FIG. 2.

FIG. 2 depicts an obstacle cone 225 and an obstacle cone 235, both of which arise for an agent in question (not shown) as a result of the presence of other nearby agents (also not shown). An initial velocity for the agent in question is represented by a point 215. Embodiments of the invention call for separating obstacle cones 225 and 235 into “segments,” which are lengths of the cone boundary lines terminated by a line end or by an intersection with another line segment. (By way of illustration, FIG. 2, for example, shows a line segment 237 within obstacle cone 235 and further shows line segments 227 and 228 within obstacle cone 225.) Next, the cone segments are divided into “inside” and “outside” regions depending on their location either inside or outside the other cones, as illustrated (where “outside” regions include regions on cone boundaries, provided these are not inside any other cones). Testing inside/outside cone segments is basically a linear constraint check, and can be represented by an expression of the form Ax+By<C. Following the division into inside and outside segments, the minimum distance of each segment from the original point is computed in order to find each segment's closest velocity point (i.e., the point on each segment that is closest to the initial velocity point), and then, from these closest points, the overall closest velocity point is chosen as the new velocity. This point is represented in FIG. 2 by a point 217.

In some scenarios it may not be possible to find a solution. In these cases, the least significant constraint is removed (e.g., the agent that is least important for the agent in question is ignored), and the optimization problem is resolved according to the steps outlined above. As an example, the least important agent may be taken as the agent that is farthest away from the agent in question, or the agent that is moving in a direction directly opposite the motion of the agent in question, or that otherwise may be least likely to affect the agent in question.

Embodiments of the invention enable crowd simulation execution times (for numbers of agents varying from 100 to 250,000 and beyond) that are an order of magnitude faster than the best execution times reported in the literature. In addition, embodiments of the invention scale nearly linearly with large number of cores (32 and beyond), and also can exploit data-level parallelism to achieve even faster speedups. On an 8-core Intel Penryn system, for example, a 7× parallel scaling overall has been observed. When simulated with a many-core simulator, a 29× scaling on 32 cores was achieved. All together, on an 8-core, 3.2 GHz Penryn system, embodiments of the invention are able to simulate 15,000 agents at 58 FPS (frames per second) and 5,000 agents in a complex environment at 121 FPS.

The foregoing results were obtained, and embodiments of the invention were tested and compared to existing methods, using input data such as will now be described.

Circle-100: 100 agents start arranged uniformly around a circle and try to move directly through the circle to their antipodal position on the other side. The scenario becomes very crowded when all the agents meet in the middle, leading to swirling behavior.

Four-Streams: 2,000 agents are organized as four streams that walk along the diagonals of a square. Smooth motion, lane formation, and some swirls are observed.

Back & Forth: Between 10 and 100 agents move back and forth along a line. This test was run side-by-side with OpenSteer (a C++ library to help construct steering behaviors for autonomous characters in games and animation) to compare the number of collisions of unmodified OpenSteer versus collisions of OpenSteer combined with embodiments of the invention.

Building Evacuation: Agents are set up in initial positions in different rooms of an office building. The scene has 218 obstacles and the roadmap consists of 429 nodes and 7200 edges. The agents move towards the goal positions corresponding to the exit signs. Three versions of this scenario were used, with 500, 1000, and 5000 agents, respectively.

Stadium Scene: This simulates the motion of 25,000 agents as they exit from their seats out of a stadium. The scene has around 1400 obstacles and the roadmap consists of almost 2000 nodes and 3200 edges. The agents move towards the corridors, leading to congestion and highly-packed scenarios.

City Simulation: A city model with buildings and streets and 1500 obstacles was used. The roadmap has 480 nodes and 916 edges. The motion of different agents as they walk around the city and at intersections is simulated. The agents move at different speeds and overtake each other and avoid collisions with oncoming agents. Three versions of this scenario were used, with 10,000, 100,000 and 250,000 agents, respectively.

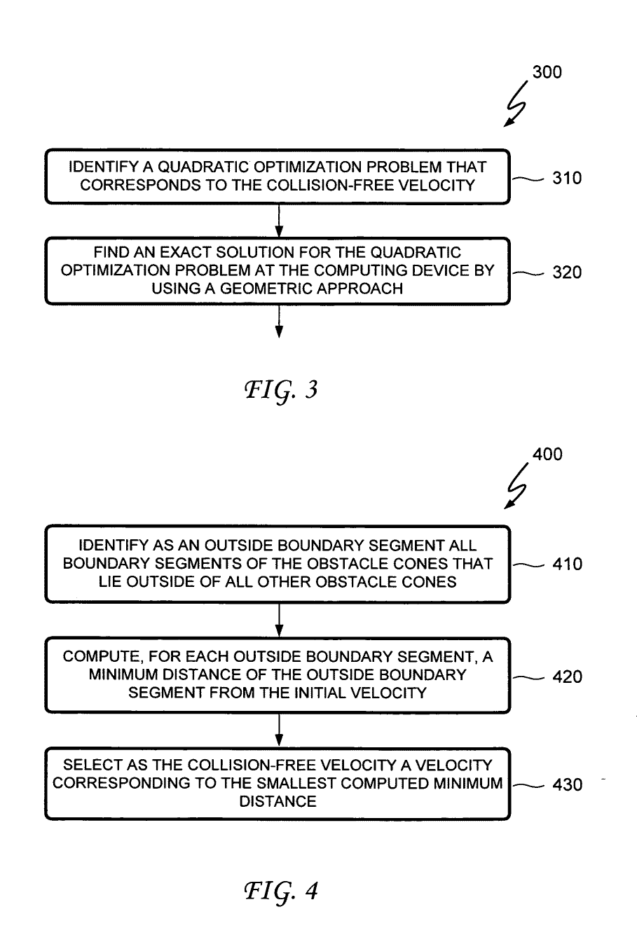

FIG. 3 is a flowchart illustrating a method 300 of computing a collision-free velocity for an agent in a crowd simulation environment according to an embodiment of the invention. The collision-free velocity is computed using a computing device. In one embodiment, the computing device can be connected via a communications network to a second computing device.

A step 310 of method 300 is to identify a quadratic optimization problem that corresponds to the collision-free velocity. As an example, the quadratic optimization problem can be similar to expression (1) that appears above. As another example, the computing device can be a client computer, the second computing device can be a server, and the communications network can be the Internet.

A step 320 of method 300 is to find an exact solution at the computing device for the quadratic optimization problem by using a geometric approach. In certain embodiments, the geometric approach involves identifying obstacle cones for the agent in a velocity space and finding a point that lies outside of the obstacle cones (where the point represents the collision-free velocity).

In some embodiments, finding the (collision-free velocity) point comprises identifying a plurality of obstacle cone boundary segments, identifying a subset of the obstacle cone boundary segments that lie outside of all of the obstacle cones, computing (for each obstacle cone boundary segment in the subset) a minimum distance from an initial point in the velocity space that corresponds to an initial velocity of the agent, and selecting a smallest one of the computed minimum distances. This smallest one of the minimum distances will be the point in question, i.e., the collision-free velocity.

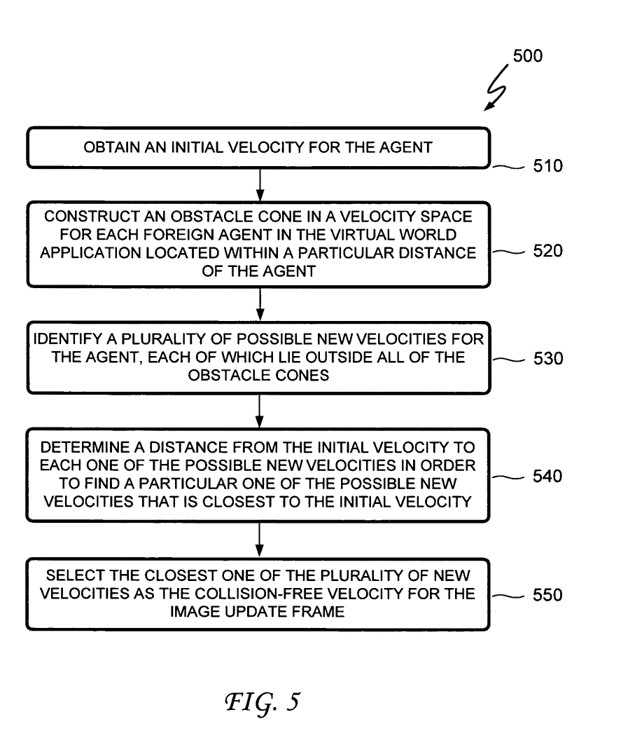

FIG. 4 is a flowchart illustrating a method 400 of computing a collision-free velocity for an agent in a crowd simulation environment in which the agent has an initial velocity and is associated with a plurality of obstacle cones residing in a velocity space according to an embodiment of the invention. Method 400 addresses a situation that is similar to that addressed by method 300 but is described in a different way.

A step 410 of method 400 is to identify as an outside boundary segment all boundary segments of the obstacle cones that lie outside of all other obstacle cones. As an example, the obstacle cones can be similar to obstacle cones 125, 135, 225, and 235 that are shown in FIGS. 1 and 2 and the outside boundary segments can be as defined above in the discussion of FIG. 2. As mentioned above, in situations where no outside boundary segment exists the method further comprises ignoring one of the obstacle cones, e.g., the obstacle cone that is least likely to affect the agent or, more generally, an obstacle cone that is less likely than another obstacle cone to affect the agent. Possible identities of such cones were discussed above.

A step 420 of method 400 is to compute, for each outside boundary segment, a minimum distance of the outside boundary segment from the initial velocity. This computation may be accomplished simply by measuring the Euclidian distance (using standard techniques) between points in a velocity space.

A step 430 of method 400 is to select as the collision-free velocity a velocity corresponding to the smallest computed minimum distance.

FIG. 5 is a flowchart illustrating a method 500 of computing a collision-free velocity for an agent in a Virtual World application according to an embodiment of the invention. Method 500 addresses a situation that is similar to those addressed by methods 300 and 400 but is described in a different way. Each one of steps 510-550 of method 500 are performed for each image update frame or time step of a visual simulation loop of the Virtual World application.

A step 510 of method 500 is to obtain an initial velocity for the agent. It should be understood that this does not require (though it does permit) an actual calculation to be done; it simply requires that the initial velocity be known prior to completing the subsequent steps. Thus, the initial velocity may be calculated, received from the Virtual World server, or obtained in some other way.

A step 520 of method 500 is to construct an obstacle cone in a velocity space for each foreign agent in the Virtual World application located within a particular distance of the agent. As first described above, each such obstacle cone represents a set of all velocities that will result in a collision between the agent and a particular foreign agent assuming no change in velocity for the particular foreign agent.

A step 530 of method 500 is to identify a plurality of possible new velocities for the agent, each of which lie outside all of the obstacle cones. In one embodiment, step 530 comprises identifying a plurality of obstacle cone boundary segments, identifying a subset of the obstacle cone boundary segments that lie outside of all of the obstacle cones, and for each obstacle cone boundary segment in the subset, computing a minimum distance from an initial point in the velocity space that corresponds to an initial velocity of the agent.

A step 540 of method 500 is to determine a distance from the initial velocity to each one of the possible new velocities in order to find a particular one of the possible new velocities that is closest to the initial velocity. hi one embodiment, finding the particular one of the possible new velocities comprises minimizing (x−x₀)²+(y−y₀)² such that Aᵢx+Bᵢy<Cᵢ for each one of the obstacle cones, where (x₀, y₀) is the initial velocity, (x, y) is the collision-free velocity of the agent, and Aᵢx+Bᵢy<Cᵢ is a linear constraint check.

A step 550 of method 500 is to select the closest one of the plurality of new velocities as the collision-free velocity for the image update frame.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the crowd simulation calculation methods and related methods discussed herein may be implemented in a variety of embodiments, and that the foregoing discussion of certain of these embodiments does not necessarily represent a complete description of all possible embodiments.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of computing a collision-free velocity for an agent in a crowd simulation environment using a computing device, the method comprising:
identifying a quadratic optimization problem that corresponds to the collision-free velocity; and
finding an exact solution for the quadratic optimization problem at the computing device by using a geometric approach.

2. The method of claim 1 wherein:
the geometric approach involves:
identifying obstacle cones for the agent in a velocity space; and
finding a point that lies outside of the obstacle cones, the point representing the collision-free velocity.

3. The method of claim 2 wherein:
finding the point comprises:
identifying a plurality of obstacle cone boundary segments;
identifying a subset of the obstacle cone boundary segments that lie outside of all of the obstacle cones;
for each obstacle cone boundary segment in the subset, computing a minimum distance from an initial point in the velocity space that corresponds to an initial velocity of the agent; and
selecting a smallest one of the computed minimum distances.

4. The method of claim 1 wherein:
the quadratic optimization problem comprises minimizing (x−x₀)²+(y−y₀)² such that Aᵢx+Bᵢy<Cᵢ for all segments of the obstacle cones, where (x₀, y₀) is an original velocity of the agent, (x, y) is the collision-free velocity of the agent, and Aᵢx+Bᵢy<Cᵢ is a linear constraint check.

5. A method of computing a collision-free velocity for an agent in a crowd simulation environment in which the agent has an initial velocity and is associated with a plurality of obstacle cones residing in a velocity space, the method comprising:
identifying as an outside boundary segment all boundary segments of the obstacle cones that lie outside of all other obstacle cones;
for each outside boundary segment, computing a minimum distance of the outside boundary segment from the initial velocity; and
selecting as the collision-free velocity a velocity corresponding to a smallest computed minimum distance.

6. The method of claim 5 further comprising:
ignoring one of the obstacle cones in cases where no outside boundary segment exists.

7. The method of claim 6 wherein:
the ignored obstacle cone is the obstacle cone that is least likely to affect the agent.

8. A method of computing a collision-free velocity for an agent in a Virtual World application, the method comprising:
for each image update frame of a visual simulation loop for the Virtual World application:
obtaining an initial velocity for the agent;
constructing an obstacle cone in a velocity space for each foreign agent in the Virtual World application located within a particular distance of the agent, each such obstacle cone representing a set of all velocities that will result in a collision between the agent and a particular foreign agent assuming no change in velocity for the particular foreign agent;
identifying a plurality of possible new velocities for the agent, each of which lie outside all of the obstacle cones;
determining a distance from the initial velocity to each one of the possible new velocities in order to find a particular one of the possible new velocities that is closest to the initial velocity; and
selecting the closest one of the plurality of possible new velocities as the collision-free velocity for the image update frame.

9. The method of claim 8 wherein:
identifying the plurality of possible new velocities comprises:
identifying a plurality of obstacle cone boundary segments;
identifying a subset of the obstacle cone boundary segments that lie outside of all of the obstacle cones; and
for each obstacle cone boundary segment in the subset, computing a minimum distance from an initial point in the velocity space that corresponds to an initial velocity of the agent.

10. The method of claim 8 wherein:
finding the particular one of the possible new velocities comprises minimizing (x−x₀)²+(y−y₀)² such that Aᵢx+Bᵢy<Cᵢ for each one of the obstacle cones, where (x₀, y₀) is the initial velocity, (x, y) is the collision-free velocity of the agent, and Aᵢx+Bᵢy<Cᵢ is a linear constraint check.
